(19) United States
(12) Patent Application Publication
(10) Pub. No.: US 2013/0246006 A1
(43) Pub. Date: Sep. 19, 2013

(54) METHOD FOR KALMAN FILTER STATE ESTIMATION IN BILINEAR SYSTEMS

(71) Applicants: ABDULLAH AL-MAZROOEI, ALMADINAH ALMONAWRA (SA); MOHAMED EL-GEBEILY, DHAHRAN (SA); JAAFAR AL-MUTAWA, DHAHRAN (SA)

(72) Inventors: ABDULLAH AL-MAZROOEI, ALMADINAH ALMONAWRA (SA); MOHAMED EL-GEBEILY, DHAHRAN (SA); JAAFAR AL-MUTAWA, DHAHRAN (SA)

(73) Assignee: KING FAHD UNIVERSITY OF PETROLEUM AND MINERALS, DHAHRAN (SA)

(21) Appl. No.: 13/419,305

(22) Filed: Mar. 13, 2012

(51) Int. Cl. G06F 15/00

(52) U.S. Cl. 702/190

(57) ABSTRACT

The method for Kalman filter state estimation in bilinear systems provides for state estimation in dynamic systems, and is a bilinear extension of the Kalman filter and the Kalman smoother. The method for Kalman filter state estimation in bilinear systems introduces a nonlinear state equation coupled with a linear measurements equation. The specific nonlinearity is of the bilinear form, depending upon the system dynamics.

### BACKGROUND OF THE INVENTION

1. Field of the Invention

The present invention relates to state estimation in dynamic systems, and particularly to a bilinear extension of the Kalman filter and the Kalman smoother.

2. Description of the Related Art

The Kalman filter is an estimator for the linear-quadratic problem, which is the problem of estimating the instantaneous state of a linear dynamic system perturbed by white noise using measurements that are linearly related to the state, but are also corrupted by white noise. The Kalman filter produces values that tend to be closer to the true values of the measurements and their associated calculated values by predicting an estimate of uncertainty of the predicted value via a weighted average of the predicted and measured values. The Kalman filter is also an algorithm for efficient performance of the exact inference in a linear state space model that has some statistical properties. The resulting estimator is statistically optimal with respect to some quadratic function of the estimation error.

Viewed mathematically, the Kalman filter is a set of equations that provides an efficient recursive solution of the least square method. It provides estimates of the past, present, and future states, and it can do so when the precise nature of the system model is unknown.

The Kalman estimator may also be adapted as a smoother. A smoother estimates the state of a system at time k, using measurements made before and after time k. The accuracy of a smoother is generally superior to that of a filter, since it uses more measurements for its estimate. The Kalman smoother can be derived from the Kalman filter model.

The general derivation methodology for the Kalman smoother uses the Kalman filter for measurements up to (each) time k that the state is to be estimated, combined with another algorithm also derived from the Kalman filter for the measurements beyond that time. This second algorithm for the smoother can be derived by running the Kalman filter backward from the last measurement to just past k, and then optimally combining the two independent estimates (forward and backward) of the state at time k based on the two independent sets of measurements.

In the following, the Kalman filter for a linear-discrete Gaussian state space model is considered. Initially, the nonlinear Kalman filter is examined. A discrete-time linear state space model within a dynamical system may be represented as:

xₖ₊₁=Axₖ+wₖ, (1)

with measurements

yₖ=Cxₖ+vₖ, (2)

where xₖε [symbol] ⁿ is the system state vector at time k (i.e., xₖ represents an n-dimensional real vector), A ε [symbol] ^{n×n} is the transition matrix (an n×n matrix), yₖε [symbol] ^{p} is the corresponding measurement vector at time k, C ε [symbol] ^{p×n} is the observation (or “measurement”) matrix (a p×1 matrix), wₖε [symbol] ⁿ is the dynamical (or system) noise at time k, and vₖε [symbol] ^{p} is the observation (or measurement) noise at time k.

wₖ and vₖ are both uncorrelated, white and Gaussian, with zero mean and covariance Q and R, respectively. In other words, wₖ˜N(0, Q); vₖ˜N(0, R); E(wₖwₗ^{T})=Q for k=1 and E(wₖ wₗ^{T})=0 for k≠1; E(vₖvₗ^{T})=R for k=1 and E(vₖvₗ^{T})=0 for k≠1; and E(wᵢvⱼ^{T})=0 for ∀i, j, where E represents the expectation.

From the above, for the Kalman filter, the predicted state estimate (a priori) is given by equation (1) as xₖ₊₁=Axₖ+wₖ, and the predicted (a priori) estimate covariance would be given by Pₖ^{f}=AP_{f}^{f}A^{T}+Q, wherein the superscript “f” represents the forecast (e.g., xₖ^{f} represents the forecast state of xₖ). The updated (a posteriori) state estimate is given by xₖ^{a}=xₖ^{f}+Kₖ(yₖ−Cxₖ^{f}), where the superscript “a” represents the estimation (e.g., xₖ^{a} is the estimation of xₖ) and Kₖ is the optimal Kalman gain, given by Kₖ=Pₖ^{f}C^{T}(CPₖ^{f}C^{T}+R)⁻¹. The updated (a posteriori) estimate covariance is given by Pₖ^{a}=Pₖ^{f}−KₖCPₖ^{f}.

With regard to the Kalman smoother, xₖ is obtained based on data samples y₁, . . . , yₜ, where k≦t (denoted as xₖ^{t}). Such estimators are generally referred to as “smoothers” since a time plot of the sequence {xₖ^{t}: k=1, . . . , t} is typically smoother than the forecasts {xₖ^{k-1}: k=1, . . . , t} or the filter {xₖ^{k}: k=1, . . . , t}. Thus, smoothing implies that each estimated value is a function of the past, present and future, whereas the filter estimator depends on the past and the present. The forecast depends on only the past. For the Kalman smoother, the updated estimate covariance is given by Pₖ^{t}=Pₖ^{a}+Jₖ└Pₖ₊₁^{t}−Pₖ₊₁^{f}┘Jₖ^{T}, where Jₖ=Pₖ^{a}A^{T}(Pₖ₊₁^{f})⁻¹. The lag-one covariance smoother is a type of smoother problem, which is a set of recursions for obtaining P_{k+1,k}^{t}. For the lag-one covariance smoother, P_{k,k-1}^{t}=Pₖ^{a}Jₖ₋₁^{T}+Jₖ└P_{k+1,k}^{t}−APₖ^{a}┘Jₖ₋₁^{T}.

The Kalman filter is an algorithm, commonly used since the 1960s, for improving vehicle navigation (among other applications, although aerospace is typical), that yields an optimized estimate of the system's state (e.g., position and velocity). The algorithm works recursively in real time on streams of noisy input observation data (typically, sensor measurements) and filters out errors using a least-squares curve-fit optimized with a mathematical prediction of the future state generated through a modeling of the system's physical characteristics. The model estimate is compared to the observation and this difference is scaled by the Kalman gain, which is then fed back as an input into the model for the purpose of improving subsequent predictions. The gain can be “tuned” for improved performance. With a high gain, the filter follows the observations more closely. With a low gain, the filter follows the model predictions more closely. This method produces estimates that tend to be closer to the true unknown values than those that would be based on a single measurement alone or the model predictions alone.

The Kalman filter has many applications in technology, and is an essential part of space and military technology development. A very simple example (and perhaps the most commonly used type of Kalman filter) is the phase-locked loop, which is now ubiquitous in FM radios and most electronic communications equipment. Another common application is with guidance, navigation and control of vehicles, like aircraft or spacecraft. Sensors are used to make measurements of the vehicle's state (its position and velocity at the time of the measurement), but such measurements are intermittent and have significant stretches of time between measurements. Also, the measurements are corrupted with a certain amount of error, including noise.

The Kalman Filter algorithm is an optimized method for determining the best estimation of the vehicle's state. The basic concept is similar to simple mathematical curve fitting of data points using a least-squares approximation (where the deviation is squared so that negative errors will not cancel out positive ones) and enables predictions of the state into future time steps. The most basic concepts of the filter are related to interpolation and extrapolation, where data estimates are filled in between given points and the latter involves data estimates being extended beyond the given set (as with future estimates).

In each time step, the Kalman filter produces estimates of the true unknown values, along with their uncertainties. Once the outcome of the next measurement is observed, these estimates are updated using a weighted average, with more weight being given to estimates with lower uncertainty. From a theoretical standpoint, the main assumption of the Kalman filter is that the underlying system is a linear dynamical system and that all error terms and measurements have a Gaussian distribution (often a multivariate Gaussian distribution). Extensions and generalizations to the method have also been developed. The underlying model is a Bayesian model similar to a hidden Markov model, but where the state space of the latent variables is continuous and where all latent and observed variables have Gaussian distributions.

The Kalman filter may be viewed as a type of “observer,” that helps to estimate the state variables of a dynamical system. For example, in general, individual state variables of a dynamic system cannot be determined exactly by direct measurements. Rather, measurements associated with the state variables, e.g., sensor data in a control system, may be a function of the state variables. In addition, such measurements are generally subject to measurement error, which, in one embodiment, may be modeled as random noise. Further, the system itself may also be subjected to random or other disturbances. The Kalman filter estimates the state variables based on the noisy measurements.

In FIG. 8, a simplified system 200 is illustrated. The system 200 includes one or more sensors 202 that provide data to an electronic state observer 100. The state observer 100 outputs a state (e.g., a real valued array of state variables) to a control system 206, which outputs signals to one or more controls 208 based on the state output by the state observer 100. As an example, the system 200 may be a control system of an aircraft or spacecraft. In such a system, the sensors 202 may include, for example, one or more of attitude, velocity, position, altitude, etc., while the controls 208 may include control surfaces, engine controls, etc. The state observer 100 is the Kalman filter, having a corresponding covariance matrix for which positive definiteness is to be maintained in order to maintain filter stability. In this example, the control system 206 receives aircraft state data from the Kalman filter 100, which uses data from the sensors 202 to update its estimate of one or more state variables associated with the aircraft. The control system 206 generates control signals to the controls 208 of the aircraft to achieve a selected control operation.

FIG. 9 illustrates the Kalman filter algorithm, using the “observer” view noted above. At step 10, the method begins with the system 200 generating an observer, e.g., a Kalman filter, for estimation of at least one state variable (contained within the state vector) associated with the system. The Kalman filter 100 provides periodically updated state variables given a sequence of observations (i.e., sensor data) about those state variables. The data from the sensors 202 generally includes some error or noise, such as measurement errors that can depend on the sensor, the operational environment, the nature of the measured value, etc.

The Kalman filter helps to remove the effects of the errors to estimate the state variables of the system. The Kalman filter is a recursive estimator or state observer. Hence, the estimated state from the previous step and a new sensor measurement are used to compute the estimate for the current state. The Kalman filter is used in two steps, i.e., a prediction step and an update step. The prediction step uses the state estimate from the previous time step to produce an estimate of the state at the current time step. In the update step, sensor measurement information at the current time step is used to refine this prediction to arrive at a new state estimate, again for the current time step. The state observer 100 is represented by the Kalman filter defined above.

In step 12, the state observer 100 receives the data from the sensors 202. Next, at step 14, the observer calculates the initial estimates of the state vector xₖ₋₁ and the covariance Pₖ₋₁. At step 16, the state vector and covariance are projected ahead by one time increment, as xₖ₊₁=Axₖ+wₖ and Pₖ^{f}=AP_{f}^{f}A^{T}+Q, respectively. At step 18, the Kalman gain is computed as Kₖ=Pₖ^{f}C^{T}(CPₖ^{f}C^{T}+R)⁻¹. At step 20, a new set of measurements yₖ are taken from sensors 202 to further update the state vector and covariance as xₖ^{a}=xₖ^{f}+Kₖ(yₖ−Cxₖ^{f}) and Pₖ^{a}=Pₖ^{f}−KₖCPₖ^{f}, respectively. These updated estimates are then fed back to step 16 for incremental projection by the next time increment.

With regard to identification of the linear Gaussian state-space model, “system identification” is a general term to describe the mathematical tools and algorithms that build dynamical models from measurement data. System identification plays an important role in uncertain dynamical systems. The Expectation-Maximization (EM) algorithm is a broadly applicable approach to the iterative computation of the maximum likelihood (ML) estimates, which are useful in a variety of incomplete data problems. On each iteration of the EM algorithm, there are two steps, the Expectation step (E-step) and the Maximization step (M-step). The EM algorithm is a technique that can be use to estimate the parameters after filling in the initial values for the missing data. The latter are then updated by their predicted values using these initial parameter estimates. The parameters are then re-estimated, and so on, proceeding iteratively until convergence. This technique is generally considered to be intuitive and natural.

The Kalman filter and the Kalman smoother are the basic tools for calculating the expectation in the E-step. The discrete-time linear state space model within a dynamical system is given above in equations (1) and (2). In this model, the initial state vector x₀ is assumed to be a Gaussian random vector with a mean μ and a covariance V, where x₀˜N(μ, V).

The maximum likelihood estimator for the parameters in this model is given by application of the EM algorithm. Using the Kalman filter and the Kalman smoother, xₖ^{t}=Eₜ(xₖ)=E(xₖ|{y}₁^{t}) (where E represents the expectation); Pₖ^{t}=Cov(xₖ|{y}₁^{t}), (where Cov represents the covariance); and P_{k,k-1}^{t}=Cov(xₖ,xₖ₋₁|{y}₁^{t}). For the M-step, the parameters of the system (A, C, Q, R and μ) are collected in a vector α={A, C, Q, R, μ}. To estimate these parameters, the corresponding partial derivatives of the expected log-likelihood function are taken, and then set to zero. Thus, αᵢ is updated as αᵢ₊₁. In other words, αᵢ₊₁={A(i+1), C(i+1), Q(i+1), R(i+1), μ(i+1)} is obtained by maximizing the log likelihood function with respect to each parameter.

The value of μ is simply given by μ=x₀^{t}=Eₜ(x₀). A is expressed as A(i+1)=γβ⁻¹, where

$$γ = {\sum }_{k = 0}^{t - 1} ( {P}_{k + 1 , k}^{t} + {{x}_{k + 1}^{t} ( {x}_{k}^{t} )}^{T} ) and β = {\sum }_{k = 0}^{t - 1} ( {P}_{k}^{t} + {{x}_{k}^{t} ( {x}_{k}^{t} )}^{T} ) .$$

C is given by C(i+1)=εβ⁻¹, where

$$ɛ = {\sum }_{k = 0}^{t - 1} {E}_{t} ( {y}_{k} {x}_{k}^{T} ) .$$

Q is given by Q(i+1)=t⁻¹(σ−γβ⁻¹γ^{T}), where

$$σ = {\sum }_{k = 0}^{t - 1} ( {P}_{k}^{t} + {x}_{k}^{t} {x}_{k}^{{t}^{T}} ) .$$

Lastly, R is given by R(i+1)=t⁻¹(ξ−εβ−1ε^{T}), where

$$ξ = {\sum }_{k = 0}^{t - 1} {E}_{t} ( {y}_{k} {y}_{k}^{T} ) .$$

In order to identify the parameters of the state-space model using the EM algorithm to obtain the maximum likelihood estimation vector \hat{α}, first the initial values of A(0), C(0), Q(0), R(0) and μ(0) are selected, and then xₖ^{t}, Pₖ^{t} and P_{k,k-1}^{t} are computed using the Kalman smoother. The conditional expectation of the log likelihood function is then calculated, and then {A(i+1),C(i+1),Q(i+1),R(i+1), μ(i+1)} are computed to find the next iterative estimated parameters that maximize the conditional expectation of the log likelihood. These new parameters are then inserted back into the state-space model, and computed using the Kalman smoother. These steps are repeated until the log likelihood converges.

When the dynamical system and measurements system of the state-space model are linear, the Kalman filter is the optimal estimator. However, in most “real world” processes of interest, the dynamical and/or the measurements systems are nonlinear. Thus, a suitable extension of the Kalman filter is needed. Both the Lorenz-96 model and the Lotka-Volterra model, which are used for atmospheric dynamics, biology, chemistry, and control systems, are examples of bilinear models. Generally, bilinear systems are nonlinear systems that are of great interest, as they represent a wide variety of important physical processes. Bilinear systems can also be used in approximation or alternate representations for a range of other nonlinear systems. Further, bilinear models may be used to model nonlinear processes in signal, image and communication systems. Bilinear systems may be represented as state-space models. However, bilinear models do not work with the traditional Kalman filter. It would, therefore, be desirable to extend the Kalman filter and Kalman smoother to be able to handle such bilinear systems.

Thus, a method for Kalman filter state estimation in bilinear systems solving the aforementioned problems is desired.

### SUMMARY OF THE INVENTION

The present invention relates to state estimation in dynamic systems, and particularly to a bilinear extension of the Kalman filter and the Kalman smoother. The method for Kalman filter state estimation in bilinear systems introduces a nonlinear state equation coupled with a linear measurements equation. The specific nonlinearity is of the bilinear form, depending upon the system dynamics.

The method for Kalman filter state estimation in bilinear systems includes the steps of: (a) generating an observer in an electronic device for estimating a state vector xₖ, associated with a bilinear system, where the observer defines a covariance matrix Pₖ statistically relating the state vector xₖ, where k represents an integer time increment, and the bilinear system is defined by xₖ₊₁=Axₖ+B(xₖ [symbol] xₖ)+wₖ, where A is a transition matrix defined by the bilinear system, B is a measurement matrix defined by parameters of the bilinear system, and wₖ is system noise at time k; (b) receiving sensor data yₖ at the electronic device from a sensor, the sensor data being associated with the state vector xₖ as yₖ=Cxₖ+vₖ, where C is a measurement matrix defined by the parameters of the bilinear system and vₖ is measurement noise at time k; (e) generating initial estimates of the state vector and the covariance matrix from the sensor data and storing the initial estimates of the state vector and the covariance matrix in non-transitory computer readable memory of the electronic device; (d) calculating a projected state vector xₖ₊₁^{k} representing the state vector projected ahead by one time increment as xₖ₊₁^{l}=Axₖ^{k}+Bzₖ^{k} and storing the projected state vector xₖ₊₁^{k} in the non-transitory computer readable memory of the electronic device, where zₖ=xₖ [symbol] xₖ and zₖ^{k}=Eₖ (zₖ); (e) calculating a projected covariance matrix Pₖ₊¹ representing the covariance matrix projected ahead by one time increment as Pₖ₊₁^{k}=APₖ^{k}A^{T}+A\ddot{P}ₖ^{k}B^{T}+B(\ddot{P}ₖ^{k})^{T}A^{T}+B\dot{P}ₖ^{k}B^{T}+Q, where Q represents a covariance of the system noise wₖ, and storing the projected covariance matrix Pₖ₊₁^{k} in the non-transitory computer readable memory of the electronic device; (f) calculating a Kalman gain Kₖ₊₁ as Kₖ₊₁=Pₖ₊₁^{k}C^{T}(CPₖ₊₁^{k}C^{T}+R)⁻¹, where R is a covariance of the measurement noise vₖ, and storing the Kalman gain Kₖ₊₁ in the non-transitory computer readable memory of the electronic device; (g) receiving a new set of measurement data yₖ from the sensor and updating the state vector and the covariance matrix based upon the new set of measurement data as xₖ₊₁^{k+1}=Kₖ₊₁^{k}+Kₖ₊₁(yₖ−Cx₊₁^{k}) and P₊₁^{k+}=(I−Kₖ₊₁C)Pₖ₊₁^{k}, respectively, wherein xₖ₊₁^{k+1} represents the updated state vector for time (k+1) and Pₖ₊₁^{k+1} represents the updated covariance matrix for time (k+1), where I represents the identity matrix, and storing the updated state vector and the updated covariance matrix in the non-transitory computer readable memory of the electronic device; and (h) returning to steps (d) and (e) with the updated state vector and the updated covariance matrix, respectively.

These and other features of the present invention will become readily apparent upon further review of the following specification and drawings.

### BRIEF DESCRIPTION OF THE DRAWINGS

FIG. 1 is a block diagram illustrating an overview of a system for performing a method for Kalman filter state estimation in bilinear systems according to the present invention.

FIG. 2 is a graph illustrating calculated error between actual states and states estimated by the method for Kalman filter state estimation in bilinear systems according to the present invention.

FIG. 3 is a graph illustrating calculated error between actual states and states estimated by a Kalman smoother extension of the method for Kalman filter state estimation in bilinear systems according to the present invention.

FIG. 4 is a graph illustrating calculated error using parameters estimated by the method for Kalman filter state estimation in bilinear systems according to the present invention produced via the EM algorithm.

FIG. 5 is a graph illustrating calculated error between simulated states and states estimated by the method for Kalman filter state estimation in bilinear system according to the present inventions.

FIG. 6 is a graph illustrating calculated error between simulated states and states estimated by the ensemble Kalman filter algorithm for purposes of comparison with FIG. 5.

FIG. 8 is block diagram illustrating a system overview for implementation of a method for Kalman filter state estimation according to the prior art.

FIG. 9 is a flow chart illustrating method steps of the Kalman filter algorithm according to the prior art.

Similar reference characters denote corresponding features consistently throughout the attached drawings.

### DETAILED DESCRIPTION OF THE PREFERRED EMBODIMENTS

The discrete-time linear state space model within a dynamical system is represented by equations (1) and (2) above. The bilinear Gaussian discrete state space model is a variant on equations (1) and (2) and is represented by:

xₖ₊₁=Axₖ+B(xₖ [symbol] xₖ)+wₖ, (3)

with measurements

yₖ=Cxₖ+vₖ, (4)

where xₖε [symbol] ⁿ is the system state vector at time k (i.e., xₖ represents an n-dimensional real vector), A ⊖ [symbol] ^{n×n} is the transition matrix (an n×n matrix), yₖε [symbol] ^{p} is the corresponding measurement vector at time k, B ε [symbol] ^{n×[n(n+1)/2]} and C ε [symbol] ^{p×n} are the observation (or “measurement”) matrices (i.e., the parameters of the model), wₖε [symbol] ⁿ is the dynamical (or system) noise at time k, and vₖε [symbol] ^{p} is the observation (or measurement) noise at time k.

wₖ and vₖ are both uncorrelated, white and Gaussian, with zero mean and covariance Q and R, respectively. In other words, wₖ˜N(0, Q); vₖ˜N(0, R); E(wₖwₗ^{T})=Q for k=1 and E(wₖwₗ^{T})=0 for k≠1, E(vₖvₗ^{T})=R for k=1 and E(vₖvₗ^{T})=0 for k≠1; and E(wₖvⱼ^{t})=0, where E represents the expectation and (xₖ [symbol] xₖ) is the Kronecker product of the state xₖ with itself.

Due to the nonlinearity in the bilinear model, the estimation is performed as a set of differential equations. For the bilinear state space model of equations (3) and (4), the state vector and estimator are respectively given as:

xₖ₊₁^{k}=Axₖ^{k}+Bzₖ^{k} (5)

Pₖ₊₁^{k}=APₖ^{k}A^{T}A\ddot{P}ₖ^{k}B^{T}+B(\ddot{P}ₖ^{k})^{T}A^{T}+B\dot{P}ₖ^{k}B^{T}+Q, (6)

where zₖ=xₖ [symbol] xₖ and zₖ^{k}=Eₖ(zₖ), where E represents the expectation, and

xₖ₊₁^{k+1}=xₖ₊₁^{k}+Kₖ₊₁(yₖ−Cxₖ₊₁^{k}) (7)

Pₖ₊₁^{k+1}=(I−Kₖ₊₁C)Pₖ₊₁^{k}, (8)

where I represents the identity matrix and Kₖ is the optimal Kalman gain. In the above, xₖ^{t}=E{xₖ|{y}ₗ^{t}}=Eₜxₜ), Pₖ^{t}=E{(xₖ−xₖ^{t})(xₖ−xₖ^{t})^{T}}, zₖ^{t}=E{zₖ|{y}ₗ^{t}}=Eₜ(zₜ), \dot{P}ₖ^{t}=E{(zₖ−zₖ^{t})(zₖ−zₖ^{t})^{T}}, and \ddot{P}ₖ^{t}=Eₜ{(xₖ−xₖ^{t})(zₖ−zₖ^{t})^{T}}, where 1≦k≦t, 1≦t≦n, and {y}ₗ^{t} is the measurement sequence; i.e., {y}ₗ^{t}={yⱼ, . . . , yₜ}.

Applying a Taylor expansion to zₖ yields

$${z}_{k} = {z}_{k}^{j} + {f}^{′} ( {x}_{k}^{j} ) ( {x}_{k} - {x}_{k}^{j} ) + \frac{1}{2} H ( {x}_{k} , {x}_{k}^{j} ) ( {x}_{k} - {x}_{k}^{j} ) , \\ where \\ {z}_{k}^{j} = {E}_{j} ( {z}_{k} ) , {f}^{′} ( x ) = {[ \frac{\partial {x}_{i} {x}_{j}}{\partial {x}_{l}} ]}_{i , j , l = 1 , 2 , … , m} , and \\ H ( {x}_{k + 1} , {x}_{k + 1}^{j} ) = ( \begin{matrix}{( {x}_{k + 1} - {x}_{k + 1}^{j} )}^{T} {D}_{1} \\ {( {x}_{k + 1} - {x}_{k + 1}^{j} )}^{T} {D}_{2} \\ ⋮ \\ {( {x}_{k + 1} - {x}_{k + 1}^{j} )}^{T} {D}_{m}\end{matrix} ) , where \\ D = ( \begin{matrix}{D}_{1} \\ ⋮ \\ {D}_{m}\end{matrix} ) \qquad ( 9 )$$

is the m²×m matrix of second derivatives. Having defined zₖ^{j}, f′(x) and H(xₖ₊₁, xₖ₊₁^{j}) the bilinear state space model Kalman filter can be completed with the expressions:

\ddot{P}ₖ₊₁^{k+1}=Pₖ₊₁^{k+1}(Vₖ₊₁^{k+1})^{T} (10)

Pₖ₊₁^{k+1}=(Vₖ₊₁^{k+1})\ddot{P}ₖ₊₁^{k+1}, (11)

where the Kalman gain is given by:

$$\begin{matrix}{K}_{k + 1} = {P}_{k + 1}^{k} {{C}^{T} ( {CP}_{k + 1}^{k} {C}^{T} + R )}^{- 1} , and & ( 12 ) \\ {V}_{k + 1}^{k + 1} = {f}^{′} ( {x}_{k + 1}^{k + 1} ) + \frac{1}{2} H ( {x}_{k + 1}^{k} , {x}_{k + 1}^{k + 1} ) \\ for k = 0 , … , t . & ( 13 )\end{matrix}$$

The Kalman smoother is an estimator which operates in the time domain where t>k+1. For the interval of k=t−1, . . . , 1, the Kalman smoother is given by:

xₖ^{t}=xₖ^{k}+Jₖ(xₖ₊₁^{t}−xₖ₊₁^{k}) (14)

Pₖ^{t}=Pₖ^{k}+Jₖ(Pₖ₊₁^{t}−Pₖ₊₁^{k})Jₖ^{T}, (15)

where Jₖ=(Pₖ^{k}A^{T}+\ddot{P}ₖ^{k}B^{T})(Pₖ₊₁^{k})⁻¹. The bilinear lag-one covariance smoother is simply given by:

P_{k+1,k}^{t}=APₖ^{k}+B(\ddot{P}ₖ^{k})^{T}, and (16)

\ddot{P}_{k+1,k}^{t}=P_{k+1,k}^{t}(Vₖ^{t})^{T}. (17)

As noted above, the term system identification describes the mathematical tools and algorithms that build dynamical models from measured data. In the following, the bilinear state space model defined by equations (3) and (4) is identified using the expectation maximization algorithm. The expectation maximization (EM) algorithm is an iterative technique used for obtaining the maximum likelihood estimation. In the EM algorithm, first q(θ, θ(i))=E{log p(θ, X, Y)|Y} is computed, where p(θ, X, Y) is the maximum likelihood function. This is the E-step. Next, in the M-step, q(θ, θ(i)) is maximized with respect to θ, which is the parameter vector, given by θ={A, B, C, Q, R, V, μ}; X={x}₁^{t}={x₁, . . . , xₜ} and Y={y}₁^{t}={y₁, . . . , yₜ}.

For the bilinear state space model of equations (3) and (4), the following assumptions are applied: x₀˜N(μ, V); wₖ˜N(0, Q); and vₖ˜N(0, R). Then, q(θ, θ(i)) is given by:

$$\begin{matrix}\begin{matrix}q ( θ , θ ( i ) ) = E \{ log p ( θ , X , Y ) \vert Y \} \\ = - \frac{1}{2} log \vert V \vert - \frac{1}{2} Tr \{ {V}^{- 1} ( Δ - {\hat{x}}_{0} {μ}^{T} - μ {\hat{x}}_{0}^{T} + {μμ}^{T} ) \}\end{matrix} & ( 18 ) \\ - \frac{t}{2} log \vert Q \vert \\ - \frac{1}{2} Tr \{ {Q}^{- 1} ( \begin{matrix}Θ - Ψ {A}^{T} - Π {B}^{T} - A {Ψ}^{T} + \\ A Φ {A}^{T} - B {Π}^{T} + B Λ {B}^{T}\end{matrix} ) \} \\ - \frac{t}{2} log \vert R \vert - \frac{1}{2} Tr \{ {R}^{- 1} ( δ - Ω {C}^{T} - C {Ω}^{T} + C Φ {C}^{T} ) \} + const . , \\ where Δ = {E}_{t} ( {x}_{0} {x}_{0}^{T} ) ; {\hat{x}}_{0} = {E}_{t} ( {x}_{0} ) ; Θ = {\sum }_{k = 0}^{t - 1} {E}_{t} ( {x}_{k + 1} {x}_{k + 1}^{T} ) ; \\ Φ = {\sum }_{k = 0}^{t - 1} {E}_{t} ( {x}_{k} {x}_{k}^{T} ) ; Ψ = {\sum }_{k = 0}^{t - 1} {E}_{t} ( {x}_{k + 1} {x}_{k}^{T} ) ; Π = {\sum }_{k = 0}^{t - 1} {E}_{t} ( {x}_{k + 1} {z}_{k}^{T} ) ; \\ Γ = {\sum }_{k = 0}^{t - 1} {E}_{t} ( {x}_{k} {z}_{k}^{T} ) ; Λ = {\sum }_{k = 0}^{t - 1} {E}_{t} ( {z}_{k} {z}_{k}^{T} ) ; Ω = {\sum }_{k = 0}^{t - 1} {E}_{t} ( {y}_{k} {x}_{k}^{T} ) ; \\ δ = {\sum }_{k = 0}^{t - 1} {E}_{t} ( {y}_{k} {y}_{k}^{T} ) ; and {z}_{k} = {x}_{k} ⊗ {x}_{k} . & \end{matrix}$$

The function q(θ, θ(i)), given above in equation (18), is maximized over θ when:

$$μ = {\hat{x}}_{0} ; V = Δ ; A = Ψ {Φ}^{- 1} ; B = Π {Λ}^{- 1} ;$$

$$Q = \frac{1}{t} ( Θ - {Ψ}^{T} {Φ}^{- 1} Ψ - {ΠΛ}^{- 1} {Π}^{T} ) ;$$

$$C = Ω {Φ}^{- 1} ; and R = {t}^{- 1} \{ δ - {ΩΦ}^{- 1} {Ω}^{T} \} .$$

In the following, the above bilinear Kalman model is applied to the nonlinear estimation and identification of the Lotka-Volterra nonlinear model. The Lotka-Volterra nonlinear model has wide ranging applications in various domains of life science, biology, chemistry, economics and neural networks. In order to show the efficiency and accuracy of the present bilinear Kalman filter, the bilinear Kalman filter and smoother are applied to simultaneously estimate states and parameters from noise data of a Lotka-Volterra system.

The Lotka-Volterra predator-prey equations are a pair of first-order, nonlinear differential equations frequently used to describe the dynamics of biological systems in which two species interact; i.e., predator and prey. The Lotka-Volterra model has the following form:

$$\begin{matrix}\frac{d x}{d t} = λ x - β xy & ( 19 ) \\ \frac{d y}{d t} = β xy - γ y , & ( 20 )\end{matrix}$$

where y represents the number of predators and x represents the number of the corresponding prey,

$$\frac{d x}{d t} and \frac{d y}{d t}$$

represent the growth of the two populations against time t, and λ, β and γ are parameters representing the interaction of the two species.

The Lotka-Volterra competing species model is a system of ordinary differential equations of the following form:

$$\begin{matrix}\frac{d x}{d t} = λ x ( 1 - x ) - β xy & ( 21 ) \\ \frac{d y}{d t} = γ y ( 1 - y ) - β xy . & ( 22 )\end{matrix}$$

Equation (21) indicates that the population of the species x grows according to a logistic law in absence of species y (i.e., when y=0). Additionally, the rate of growth of x is negatively proportional to y, representing competition between members of x and members of y. The larger the population y, the smaller the growth rate of x. Similarly, equation (22) describes the rate of growth for population y.

The Lotka-Volterra competing species model can be written in the form of the present bilinear model (of equations (3) and (4)), with

$$A = ( \begin{matrix}λ & 0 \\ 0 & γ\end{matrix} ) and B = ( \begin{matrix}- λ & - β & 0 \\ 0 & - β & - γ\end{matrix} ) .$$

The same can be performed for the Lotka-Volterra predator-prey model of equations (19) and (20).

The following simulation using the present bilinear Kalman filter and bilinear Kalman smoother was performed on the nonlinear Lotka-Volterra competition model in state-space form, which is given by:

$$\begin{matrix}{x}_{k + 1} = {Ax}_{k} + {Bz}_{k} + {w}_{k} & ( 23 ) \\ {y}_{k + 1} = {Cx}_{k} + {v}_{k} , \\ where A = ( \begin{matrix}1 & 0.1 \\ - 0.1 & 1\end{matrix} ) , B = ( \begin{matrix}0.01 & 0.01 & 0 \\ 0 & - 0.01 & 0\end{matrix} ) \\ and C = ( \begin{matrix}1 & 0 \\ 0 & 1\end{matrix} ) , & ( 24 )\end{matrix}$$

and the bilinear term zₖ=xₖ [symbol] xₖ, where xₖ is the state vector. The random noise wₖ and vₖ are uncorrelated with wₖ˜(0, W) and vₖ˜(0, V), where W=0.0004I₂ and V=0.0004I₂. The initial state is

$${x}_{0} = ( \begin{matrix}1 \\ 1\end{matrix} ) .$$

The error for the estimated quantities is required in order to state the reliability of the results. The error is provided by the covariance matrix to compute the difference between the true states and the estimated states. In other words, if xₖ is the true state, and xₖ^{t} is the estimated state, then the estimation error can be computed as:

ε=∥xₖ−xₖ^{t}∥=(xₖ−xₖ^{t})^{T}(xₖ−xₖ^{t}). (25)

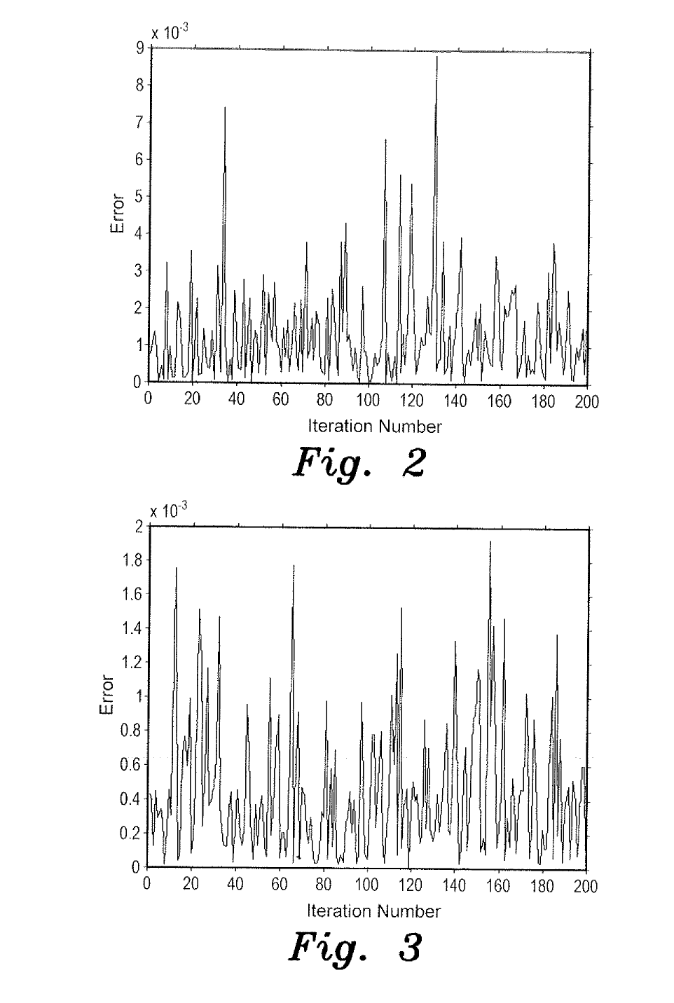

In the bilinear Kalman filter, the estimated state is xₖ₊₁. The value of xₖ₊₁^{k} can be obtained from equation (5). Having run the simulation with the present Kalman filter and Kalman smoother, it is found that the error between the true states and the estimated states via the bilinear Kalman filter is very small. The error in the case of the bilinear filter is shown in FIG. 2.

In the bilinear Kalman smoother, the estimated state is xₖ₊₁^{t} for t>k+1. The estimated state for the Lotka-Volterra model can be computed by using the bilinear Kalman smoother of equation (14). By applying the equations of this estimator to estimate the state xⱼ, the error between the true state and the estimated state is found to be very small, as shown in FIG. 3. These results show that the present bilinear Kalman filter and bilinear Kalman smoother work well and are applicable to a bilinear model.

The utility of the bilinear Kalman filter and bilinear Kalman smoother have also been simulated for estimation of bilinear system parameters via the EM approach. In this simulation, the Lotka-Volterra state space model is, once again, considered, with the parameters A, B, C, W and V being unknown. The initial value for the state in this simulation is

$${x}_{0} = ( \begin{matrix}1 \\ 1\end{matrix} ) ,$$

such that x₀˜N(μ, P). The additive noise wₖ and vₖ are uncorrelated with wₖ˜(0, W) and vₖ˜(0, V), with initial estimates of W and V. The estimation for the system of the model given by equations (23) and (24) is determined from this information about the model via the EM algorithm. The simulation begins with initial guesses for such parameters, and these are updated recursively until convergence to the true system; i.e., if the estimated parameters are very close to the true parameters, then a small error is obtained between the estimated state and the true state. The E-step and M-step are both outlined above.

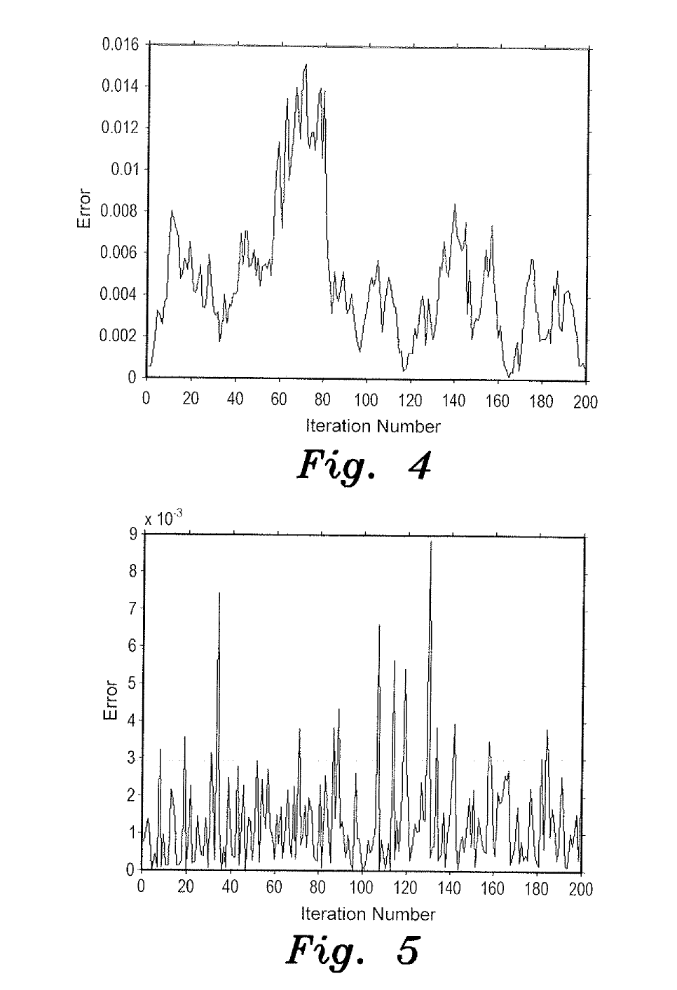

FIG. 4 shows the error between the true state and the estimated state using the estimated values of the parameters that were obtained from the simulation via the bilinear EM algorithm. The resulting small errors indicate that using the bilinear EM approach to estimate the exact values of the parameters is very reliable.

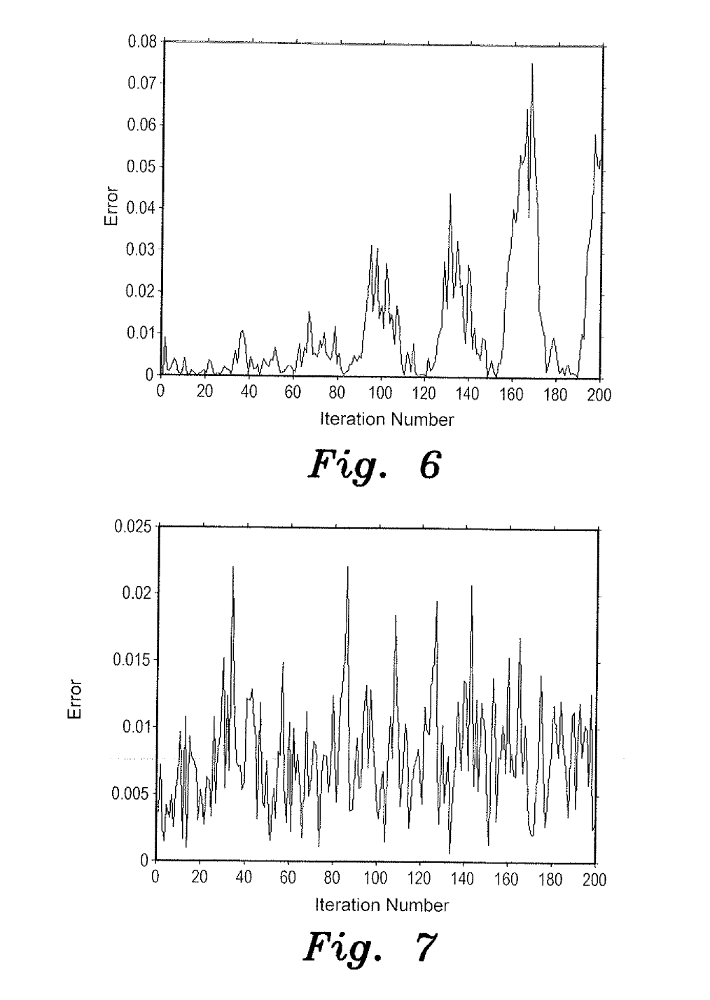

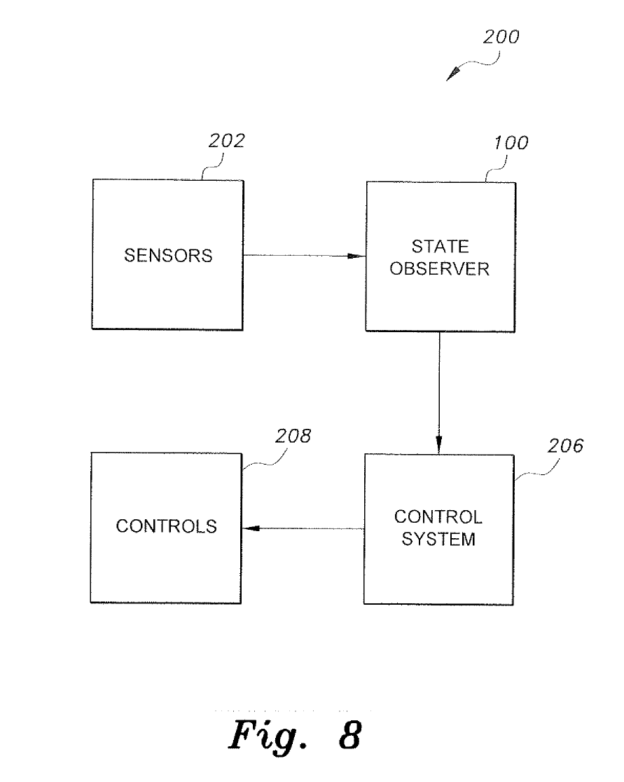

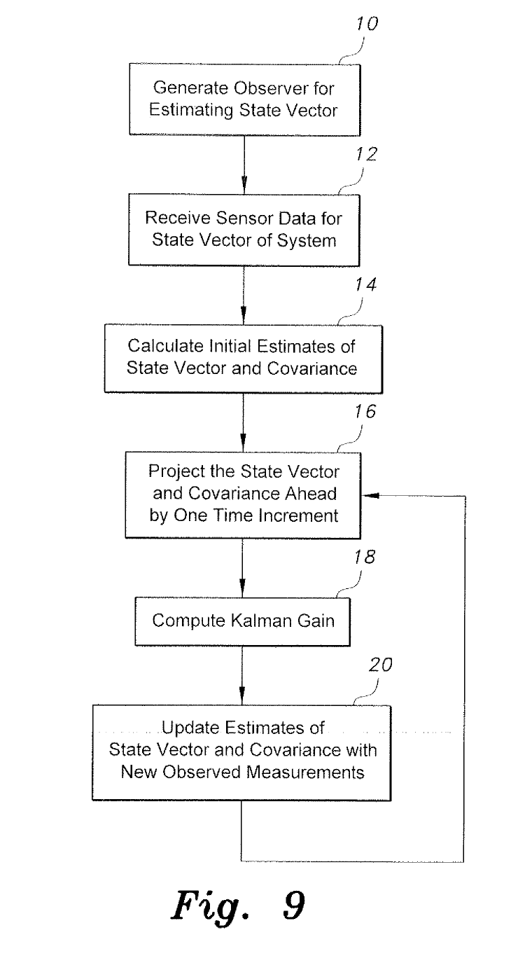

The extended Kalman filter (EKF) and the ensemble Kalman filter (EnKF) are conventional prior art filters used for nonlinear models. Application of these filters to the nonlinear Lotka-Volterra model produces relatively good results. However, when compared against the present bilinear Kalman filter, the error between the true states and the estimated states is found to be smaller with the present bilinear Kalman filter than either of the prior art filters. The error between the true states and the estimated states for the present bilinear Kalman filter is shown in FIG. 5. The same error for the extended Kalman filter is shown in FIG. 6, and the error for the ensemble Kalman filter is shown in FIG. 7. Comparing the errors, the error is found to be smallest with the present bilinear Kalman filter, thus showing that the bilinear Kalman filter produces more accurate results than either conventional prior art variant on the Kalman filter.

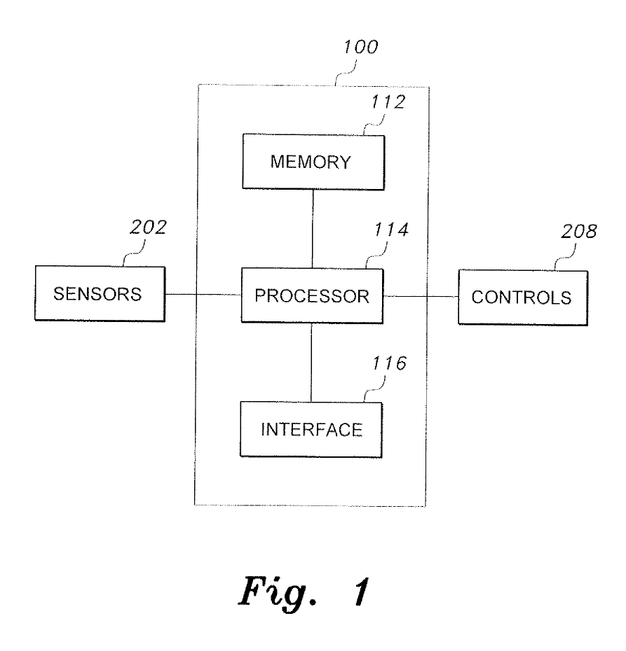

It should be understood that the calculations of state observer 100 may be performed by any suitable computer system, such as that diagrammatically shown in FIG. 1. Data is fed into system 100 by sensors 202, and may further be input via any suitable type of user interface 116, and may be stored in memory 112, which may be any suitable type of computer readable and programmable memory. Calculations are performed by processor 114, which may be any suitable type of computer processor and are fed, as control signals, to controls 208. Controls 208 may also include a display for the user, which may be any suitable type of computer display.

Processor 114 may be associated with, or incorporated into, any suitable type of computing device, for example, a personal computer or a programmable logic controller. The controls 208, the processor 114, the memory 112 and any associated computer readable recording media are in communication with one another by any suitable type of data bus, as is well known in the art.

Examples of computer-readable recording media include a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Alternatively, the present Kalman filter may be implemented by a digital signal processor, a microcontroller, an application specific integrated circuit (ASIC), or any other suitable circuit or device programmed or configured to carry out the steps of the method.

It is to be understood that the present invention is not limited to the embodiments described above, but encompasses any and all embodiments within the scope of the following claims.

We claim:

1. A method for Kalman filter state estimation in bilinear systems, comprising the steps of:
(a) generating an observer in an electronic device for estimating a state vector xₖ associated with a bilinear system, the observer defining a covariance matrix Pₖ statistically relating the state vector xₖ, where k represents an integer time increment, the bilinear system being defined by xₖ₊₁=Axₖ+B(xₖ [symbol] xₖ)+wₖ where A is a transition matrix defined by the bilinear system, B is a measurement matrix defined by parameters of the bilinear system, and wₖ is system noise at time k;
(b) receiving sensor data yₖ at the electronic device from a sensor, the sensor data being associated with the state vector xₖ as yₖ=Cxₖ+vₖ, where C is a measurement matrix defined by the parameters of the bilinear system and vₖ is measurement noise at time k;
(c) generating initial estimates of the state vector and the covariance matrix from the sensor data and storing the initial estimates of the state vector and the covariance matrix in non-transitory computer readable memory of the electronic device;
(d) calculating a projected state vector xₖ₊₁^{k} representing the state vector projected ahead by one time increment as xₖ₊₁^{k}=Axₖ^{k}+Bzₖ^{k} and storing the projected state vector xₖ₊₁^{k} in the non-transitory computer readable memory of the electronic device, where zₖ=xₖ [symbol] xₖ and zₖ^{k}=Eₖ(zₖ);
(e) calculating a projected covariance matrix Pₖ₊₁^{k} representing the covariance matrix projected ahead by one time increment as Pₖ₊₁^{k}=APₖ^{k}A^{T}+A\ddot{P}ₖ^{k}B^{T}+B(\ddot{P}ₖ^{k})^{T}A^{T}+B\dot{P}ₖ^{k}B^{T}+Q, where Q represents a covariance of the system noise wₖ, and storing the projected covariance matrix Pₖ₊₁^{k} in the non-transitory computer readable memory of the electronic device;
(f) calculating a Kalman gain Kₖ₊₁ as Kₖ₊₁=Pₖ₊₁^{k}C^{T}(CPₖ₊₁^{k}C^{T}+R)⁻¹, where R is a covariance of the measurement noise vₖ, and storing the Kalman gain Kₖ₊₁ in the non-transitory computer readable memory of the electronic device;
(g) receiving a new set of measurement data yₖ from the sensor and updating the state vector and the covariance matrix based upon the new set of measurement data as xₖ₊₁^{k+1}=xₖ₊₁^{k}+Kₖ₊₁(yₖ−Cxₖ₊₁^{k}) and Pₖ₊₁^{k+1}=(I−Kₖ₊₁C)Pₖ₊₁^{k}, respectively, wherein xₖ₊₁^{k+1} represents the updated state vector for time (k+1) and Pₖ₊₁^{k+1} represents the updated covariance matrix for time (k+1), where I represents the identity matrix, and storing the updated state vector and the updated covariance matrix in the non-transitory computer readable memory of the electronic device; and
(h) returning to steps (d) and (e) with the updated state vector and the updated covariance matrix, respectively.

2. The method for Kalman filter state estimation in bilinear systems as recited in claim 1, further comprising the step of calculating a further updated state vector xₖ^{t} as xₖ^{t}=xₖ^{k}+Jₖ(xₖ₊₁^{t}−xₖ₊₁^{k}) and a further updated covariance matrix Pₖ^{t} as Pₖ^{t}=Pₖ^{k}+Jₖ(Pₖ₊₁^{t}−Pₖ₊₁^{k})Jₖ^{T} for a time t, where t>k+1 in an interval k=t−1, . . . , 1, following the step (g) and prior to the step (h), wherein Jₖ=(Pₖ^{k}A^{T}+\ddot{P}ₖ^{k}B^{T})(Pₖ₊₁^{k})⁻¹.

3. A system for Kalman filter state estimation in bilinear systems, comprising:
a processor;
non-transitory computer readable memory coupled to the processor;
software stored in the non-transitory computer readable memory and executable by the processor, the software having:
means for generating an observer for estimating a state vector xₖ associated with a bilinear system, the observer defining a covariance matrix Pₖ statistically relating the state vector xₖ, where k represents an integer time increment, the bilinear system being defined by xₖ₊₁=Axₖ+B(xₖ [symbol] xₖ)+wₖ where A is a transition matrix defined by the bilinear system, B is a measurement matrix defined by parameters of the bilinear system, and wₖ is system noise at time k;
means for receiving sensor data yₖ from a sensor, the sensor data being associated with the state vector xₖ as yₖ=Cxₖ+vₖ, where C is a measurement matrix defined by the parameters of the bilinear system and vₖ is measurement noise at time k;
means for generating initial estimates of the state vector and the covariance matrix from the sensor data and storing the initial estimates of the state vector and the covariance matrix in the non-transitory computer readable memory;
means for calculating a projected state vector xₖ₊₁^{k} representing the state vector projected ahead by one time increment as xₖ₊₁^{k}=Axₖ^{k}+Bzₖ^{k} and storing the projected state vector xₖ₊₁^{k} in the non-transitory computer readable memory, where zₖ=xₖ [symbol] xₖ and zₖ^{k}=Eₖ(zₖ);
means for calculating a projected covariance matrix Pₖ₊₁^{k} representing the covariance matrix projected ahead by one time increment as Pₖ₊₁^{k}=APₖ^{k}A^{T}+A\ddot{P}ₖ^{k}B^{T}+B(\ddot{P}k^{k})^{T}A^{T}+B\dot{P}ₖ^{k}B^{T}+Q, where Q represents a covariance of the system noise wₖ, and storing the projected covariance matrix Pₖ₊₁^{k} in the non-transitory computer readable memory;
means for calculating a Kalman gain Kₖ₊₁ as Kₖ₊₁=Pₖ₊₁^{k}C^{T}(CPₖ₊₁^{k}C^{T}+R)⁻¹, where R is a covariance of the measurement noise vₖ, and storing the Kalman gain Kₖ₊₁ in the non-transitory computer readable memory; and
means for receiving a new set of measurement data yₖ from the sensor and updating the state vector and the covariance matrix based upon the new set of measurement data as xₖ₊₁^{k+1}=xₖ₊₁^{k}+Kₖ₊₁(yₖ−Cxₖ₊₁^{k}) and Pₖ₊₁^{k+1}=(I−Kₖ₊₁C)Pₖ₊₁^{k}, respectively, wherein x₊₁^{k+1} represents the updated state vector for time (k+1) and Pₖ₊₁⁺¹ represents the updated covariance matrix for time (k+1), where I represents the identity matrix, and storing the updated state vector and the updated covariance matrix in the non-transitory computer readable memory.

4. The system for Kalman filter state estimation in bilinear systems as recited in claim 3, further comprising means for calculating a further updated state vector xₖ^{t} as xₖ^{t}=xₖ^{k}+Jₖ(xₖ₊₁^{t}−xₖ₊₁^{k}) and a further updated covariance matrix Pₖ^{t} as Pₖ^{t}=Pₖ^{k}+Jₖ(Pₖ₊₁^{t}−Pₖ₊₁^{k})Jₖ^{T} for a time t, where t>k+1 in an interval k=t−1, . . . , 1, wherein Jₖ=(Pₖ^{k}A^{T}+\ddot{P}ₖ^{k}B^{T})(Pₖ₊₁^{k})⁻¹.

5. A computer software product that includes a non-transitory computer readable storage medium readable by a processor, the non-transitory computer readable storage medium having stored thereon a set of instructions for Kalman filter state estimation in bilinear systems, the instructions comprising:
(a) a first sequence of instructions which, when executed by the processor, causes the processor to generate an observer for estimating a state vector xₖ associated with a bilinear system, the observer defining a covariance matrix Pₖ statistically relating the state vector xₖ, where k represents an integer time increment, the bilinear system being defined by xₖ₊₁=Axₖ+B(xₖ [symbol] xₖ)+wₖ where A is a transition matrix defined by the bilinear system, B is a measurement matrix defined by parameters of the bilinear system, and wₖ is system noise at time k;
(b) a second sequence of instructions which, when executed by the processor, causes the processor to receive sensor data yₖ from a sensor, the sensor data being associated with the state vector xₖ as yₖ=Cxₖ+vₖ, where C is a measurement matrix defined by the parameters of the bilinear system and vₖ is measurement noise at time k;
(c) a third sequence of instructions which, when executed by the processor, causes the processor to generate initial estimates of the state vector and the covariance matrix from the sensor data and storing the initial estimates of the state vector and the covariance matrix in the non-transitory computer readable storage medium;
(d) a fourth sequence of instructions which, when executed by the processor, causes the processor to calculate a projected state vector xₖ₊₁^{k} representing the state vector projected ahead by one time increment as xₖ₊₁^{k}=Axₖ^{k}+Bzₖ^{k} and storing the projected state vector xₖ₊₁^{k} in the non-transitory computer readable storage medium, where zₖ=xₖ [symbol] xₖ and zₖ^{k}=Eₖ(zₖ);
(e) a fifth sequence of instructions which, when executed by the processor, causes the processor to calculate a projected covariance matrix Pₖ₊₁^{k} representing the covariance matrix projected ahead by one time increment as Pₖ₊₁^{k}=APₖ^{k}A^{T}+A\ddot{P}ₖ^{k}B^{T}+B(\ddot{P}ₖ^{k})^{T}A^{T}+B\dot{P}ₖ^{k}B^{T}+Q, where Q represents a covariance of the system noise wₖ, and storing the projected covariance matrix Pₖ₊₁^{k} in the non-transitory computer readable storage medium;
(f) a sixth sequence of instructions which, when executed by the processor, causes the processor to calculate a Kalman gain Kₖ₊₁ as Kₖ₊₁=Pₖ₊₁^{k}C^{T}(CPₖ₊₁^{k}C^{T}+R)⁻¹, where R is a covariance of the measurement noise vₖ, and storing the Kalman gain Kₖ₊₁ in the non-transitory computer readable storage medium;
(g) a seventh sequence of instructions which, when executed by the processor, causes the processor to receive a new set of measurement data yₖ from the sensor and update the state vector and the covariance matrix based upon the new set of measurement data as xₖ₊₁^{k+1}=xₖ₊₁^{k}+Kₖ₊₁(yₖ−Cxₖ₊₁^{k}) and Pₖ₊₁^{k+1}=(I−Kₖ₊₁C)Pₖ₊₁^{k}, respectively, wherein xₖ₊₁^{k+1} represents the updated state vector for time (k+1) and Pₖ₊₁^{k+1} represents the updated covariance matrix for time (k+1), where I represents the identity matrix, and storing the updated state vector and the updated covariance matrix in the non-transitory computer readable storage medium; and
(h) an eighth sequence of instructions which, when executed by the processor, causes the processor to return to the fourth and fifth sequences of instructions with the updated state vector and the updated covariance matrix, respectively.

6. The computer software product as recited in claim 5, further comprising a ninth sequence of instructions which, when executed by the processor, causes the processor to calculate further updated state vector xₖ^{t} as xₖ^{t}=xₖ^{k}+Jₖ(xₖ₊₁^{t}−xₖ₊₁^{k}) and a further updated covariance matrix Pₖ^{t} as Pₖ^{t}=Pₖ^{k}+Jₖ(Pₖ₊₁^{t}−Pₖ₊₁^{k})Jₖ^{T} for a time t, where t>k+1 in an interval k=t−1, . . . , 1, following the seventh set of instructions and prior to the eighth set of instructions, wherein Jₖ=(Pₖ^{k}A^{T}+\ddot{P}ₖ^{k}B^{T})(Pₖ₊₁^{k})⁻¹.
